(19) United States
(12) Patent Application Publication
(10) Pub. No.: US 2012/0327491 A1
(43) Pub. Date: Dec. 27, 2012

(54) HOLOGRAPHIC DISPLAY SYSTEM WITH MOTION SENSORS

(75) Inventors: Sze Ping Ong, Singapore (SG); Yufeng Yao, Singapore (SG); Chee Heng Wong, Singapore (SG); Han Kang Chong, Singapore (SG); Rani Seravanan, Singapore (SG)

(73) Assignee: Avago Technologies ECBU IP (Singapore) Pte. Ltd., Singapore (SG)

(21) Appl. No.: 13/169,608

(22) Filed: Jun. 27, 2011

(51) Int. Cl. G03H 1/10

(52) U.S. Cl. 359/10

(57) ABSTRACT

A holographic display system with motion sensors is disclosed. In one embodiment, the holographic display system is a flat screen display having display screen and a holographic overlay positioned over the display screen. A plurality of sensors are embedded in the holographic overlay. Alternatively, the plurality of sensors may be attached to a substrate, which is positioned behind the display screen. In another embodiment, the holographic display system is a projection type display in which image beams are projected from an image projector onto a holographic screen. A plurality of sensors are located on the holographic screen. In yet another embodiment, a method for sensing a user's movement using a holographic display system with motion sensors is shown.

### BACKGROUND

Recently, more and more movies are not only available in a 2-dimensional (referred to hereinafter as “2D”) format, but also in a 3-dimensional (referred to hereinafter as “3D”) format. The demand for 3-dimensional contents is not limited to cinema, but is also prevalent in the home viewing market. As a result, many Liquid Crystal Displays (referred to hereinafter as “LCDs”) available today are capable of displaying 3D images. Hologram and holography technology have been applied to flat screen LCD displays, as well as projection displays, in order to achieve the in demand 3D effect. The demand for 3D content in movies is also increasing in the gaming applications environment. In the coming years, more and more games available on major game consoles, such as Nintendo, Xbox, and PlayStation will be available in 3D. With the progress of sensing technology, some of the gaming consoles available today such, as Kinetic Xbox 360 no longer require end users to use an input device. Instead, a camera sensing system is positioned in front of a display to detect the user's movement and subsequently, the movement will be interpreted and produced as input to the game application.

One potential challenge with a camera imaging system for 3D gaming applications may be if the user moves into close proximity with the display. For example, in 2D gaming applications, most users typically remain in a relatively stationary position at least three or four feet from the screen. However, with 3D gaming applications, a user may experience images “popping out” from the screen and be responsive to actions or events occurring “in” and “out” of the screen. With 3D projection display, a user may move to a position close to the screen. This may be challenging for sensing systems using a camera, because typically camera sensing systems require a user to be positioned a predetermined minimum distance from the camera.

### BRIEF DESCRIPTION OF THE DRAWINGS

Illustrative embodiments by way of examples, not by way of limitation, are illustrated in the drawings. Throughout the description and drawings, similar reference numbers may be used to identify similar elements.

FIG. 1 illustrates an exploded, perspective view of a holographic display system having a plurality of sensors;

FIG. 2 illustrates an exploded, perspective view of a holographic display system having a plurality of embedded sensors;

FIG. 3 illustrates a cross-sectional view of a holographic overlay showing an embedded sensor;

FIG. 4 illustrates an exploded, perspective view of a holographic projection display system having a plurality of sensors located on a printed circuit board;

FIG. 5 illustrates a perspective view of a holographic projection display system having a plurality of embedded sensors; and

FIG. 6 illustrates a method for detecting a user's movement in a gaming system.

### DETAILED DESCRIPTION

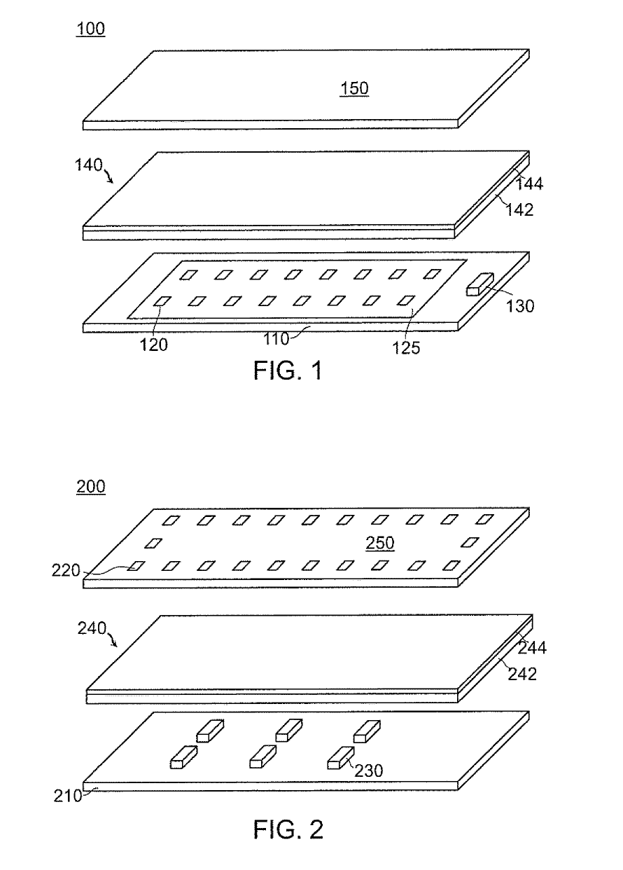

FIG. 1 illustrates an exploded, perspective view of a holographic display system 100. The holographic display system 100 comprises a substrate 110, a plurality of sensors 120, a light source 130, a display screen 140 and a holographic overlay 150. The display screen 140 further comprises a light guide 142 and an LCD panel 144 having M×N pixels. The LCD panel 144 may be connected to control electronics (not shown) for displaying images on the display screen 140. The display screen 140 may also comprise other optical layers, such as diffusers or polarizers (not shown). The light source 130 may be located on the substrate 110. The light source 130 may be configured to emit light into the display screen 140 through the light guide 142. In the embodiment shown in FIG. 1, the light source 130 is configured to emit light into the light guide 142 to provide backlighting of the display screen 140. The light source 130 shown in FIG. 1 is a side-emitting light emitting diode (referred to hereinafter as “LED”), configured to emit light into the light guide 142 from a side surface.

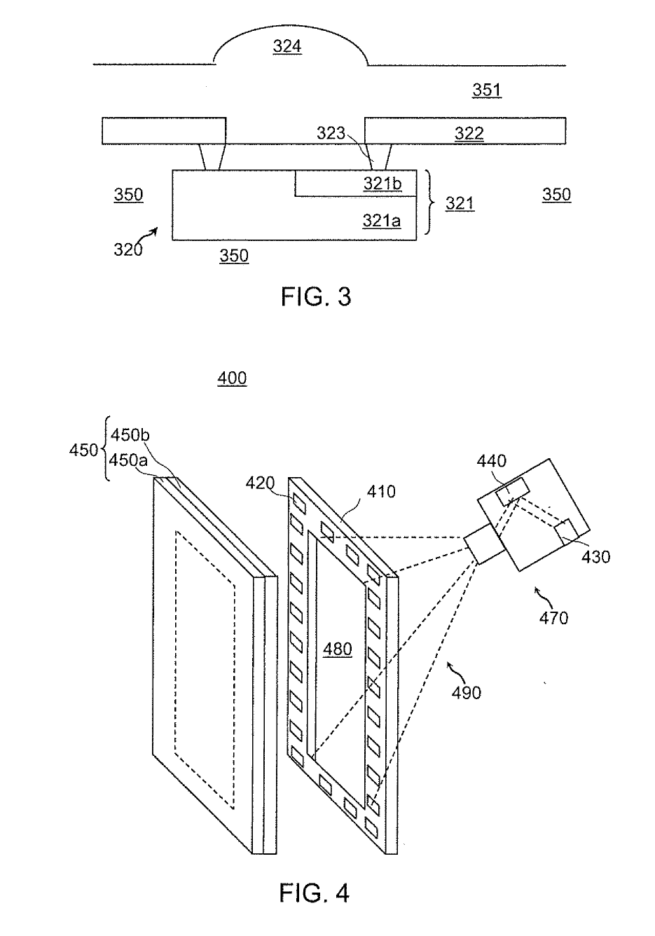

The sensors 120 are connected to control circuits or a controller configured to detect movement of a user using correlation, spatial filtering or any other similar detection methods. Generally, in order to detect movement, the sensors 120 are positioned in a periodic manner, for example in an array form, as shown in FIG. 1. In yet another embodiment, the sensors 120 may be divided into two groups arranged in alternatively interlaced column or rows configured to detect movements in accordance with the principle of spatial filters. Each of the sensors 120 may further comprise a lens 324, shown in FIG. 3, which is configured to focus light into the sensors 120. The sensors 120 may be a photodiode, a phototransistor or any other similar device. The sensors 120 may be bare dies attached and wire bonded to the substrate 110. Alternatively, the sensors 120 may be packaged devices soldered on the substrate 110. The substrate 110 may be a printed circuit board (referred hereinafter as “PCB”). The substrate 110 may be made highly reflective to minimize light loss.

The sensors 120 may be configured to detect movement of a user, typically within a position of approximately 5 feet from the holographic display system 100. The detection may be done through sensing the ambient light reflected from one or more external objects positioned in close proximity to the holographic display system 100. The ambient light may enter the holographic display system 100 through the holographic overlay 150, which may be coupled into the light guide 142. However, besides ambient light, the light emitted from the light source 130 may also fall onto the sensors 120, thus creating undesired crosstalk. One way to reduce crosstalk is to use sensors 120 that are sensitive to only a specific limited range of wavelengths outside the visible light. In one embodiment, the sensors 120 may be sensitive primarily to near infrared light (750 nm to 950 nm), but remain relatively insensitive to visible light. For example, the output of the sensors 120 corresponding to a light radiation with a wavelength of 850 nm may be 100 times larger than the output corresponding to another visible light having a wavelength of 550 nm. As the light emitted from the light source 130 is typically visible light, the crosstalk created by the light source 130 may be reduced significantly. Another method to reduce the sensitivity of the sensors 120 to visible light, a filter 125 may be applied to the sensors 120 to block the visible light substantially.

In yet another embodiment, the crosstalk may be reduced by synchronizing the sensors 120 and the light source 130, such that light emission and light detection are carried out at different times. For example, the sensors 120 may be connected to a switch capacitor circuit (not shown) so that light sensing may be done at a first time interval. On the other hand, the light source 130 may be configured to emit light at a second time interval that does not overlap with the first time interval. As the light source 130 and the sensors 120 are synchronized, the sensors 120 may be configured to avoid sensing light emitted by the light source 130. The above crosstalk elimination techniques may be used independently or in any combination.

The holographic overlay 150 may be a hologram, or a holographic optical element, or a combination of all the above. The holographic overlay 150 may be positioned such that it has a first appearance when viewed at a first angle, and a second appearance when the display screen 140 is viewed at a second angle. The effects of the holographic overlay 150, in combination with an LCD, are capable of producing a 3D image. The holographic overlay 150 may be incorporated directly onto the stack structure of the display screen 140.

The holographic display system 100 may form a portion of a gaming system (not shown). A user of the gaming system may be located at a position in close proximity to the display system 100. For example, the user may be less than one foot from the holographic display system 100 interacting with and responding to the gaming application. The plurality of sensors 120 may be located across a wide spread area of the holographic display system 100 to enable movement detection in such close proximity. In one embodiment, the sensors 120 may be arranged in an array form and each sensor 120 may be positioned 3 cm away from a neighboring sensor 120.

FIG. 2 illustrates an exploded, perspective view of a holographic display system 200. The holographic display system 200 comprises a substrate 210, a plurality of sensors 220, a plurality of light sources 230, a display screen 240 and a holographic overlay 250. The display screen 240 further comprises a light guide 242 and an LCD panel 244 having M×N pixels. The holographic display system 200 is substantially similar to the holographic display system 100, but differs at least in that the display screen 240 is a direct backlighting type and the sensors 220 are embedded on the holographic overlay 250. As the display screen 240 is a direct backlighting type, the light sources 230 may be positioned right below the light guide 242 and not beside the light guide 242. The light sources 230 may be configured to emit light directly to the light guide 242. In addition, the sensors 220 may be positioned in an outer perimeter of the holographic display system 200 such that the sensors 220 may be located at areas not used for displaying images.

The holographic overlay 250 may be made from glass or may comprise a layer of glass (not shown) made from acrylic polymer material. The sensors 220 may be formed directly on the holographic overlay, as shown in FIG. 3, which illustrates a cross-sectional view of a holographic overlay 350 located near a surface opposite the display screen 240, as shown in FIG. 2. In the embodiment shown in FIG. 3, the holographic overlay 350 is made from glass. The sensors 320 may be formed as photodiode pockets 321. The photodiode pockets 321 may be formed through an ion implantation process by implanting donors and acceptors to form a P-type area 321a and N-type area 321b. Electrical connection may be established through a conduction layer 322 and “vias” 323. The conduction layer 322 may be substantially transparent to prevent obstruction of light. For example, the conduction layer 322 may be an Indium-tin-oxide (ITO) layer, which is substantially transparent.

Typically the photodiode pockets 321 may be small and may not obstruct optical transmission. For example the size of the photodiode pockets may be approximately 20 um×20 um×50 um. The depth of the photodiode pockets 321 may affect the sensitivity of the sensors 320. A silicon dioxide layer 351 may be formed above the photodiode pockets 321. The silicon dioxide layer 351 may define a dome shape to form a lens 324 for collimating light into the photodiode pockets 321. The photodiode pockets 321 and the lens 324 may be microscopic in dimension and invisible to unaided naked human eyes.

FIG. 4 illustrates an exploded, perspective view of a holographic projection display system 400. The holographic projection display system 400 comprises a plurality of sensors 420, a substrate 410, an image projector 470 and a holographic screen 450. The image projector 470 may further comprises a light source 430 and at least an LCD modulator panel 440. The holographic screen 450 may comprise a main hologram 450a and a dispersion hologram 450b that causes images to appear 3D on the holographic screen 450 to a user.

The sensors 420 may be positioned on the substrate 410. The substrate 410 may overlay at least a portion of the holographic screen 450. However, a substantial portion of the substrate 410 may define a hollow 480 allowing modulated light beam 490 from the image projector 470 to pass through so that images can be viewed on the holographic screen 450. In the embodiment shown in FIG. 4, the sensors 420 are arranged in an outer perimeter of the holographic screen 450. As the sensors 420 are located on the substrate 410, light from the image projector 470 may not reach the sensors 420 directly. However, light from image projector 470 may reach the sensors 420 by means of a reflection caused by the holographic screen 450, although the amount may be insignificant. The coupling or crosstalk may be reduced using the filtering technique or synchronization techniques discussed in holographic display system 100, either individually or in combination.

Generally the light source 430 may be configured to emit light, which may pass through collimators (not shown) and beam splitters (not shown) before reaching the LCD modulator panel 440. The LCD modulator panel 440 may be controlled by a display driver (not shown). The display driver (not shown) is configured to modulate the light beam 490 in accordance with the images that is being projected. The LCD modulator panel 440 may comprise M×N pixels. The light may then go through one or more mirrors (not shown) and one or more lenses (not shown) before exiting the image projector 470 as an image beam 490. The image beam 490 will then be incident on the holographic screen 450 through the hollow 480 of the substrate 410.

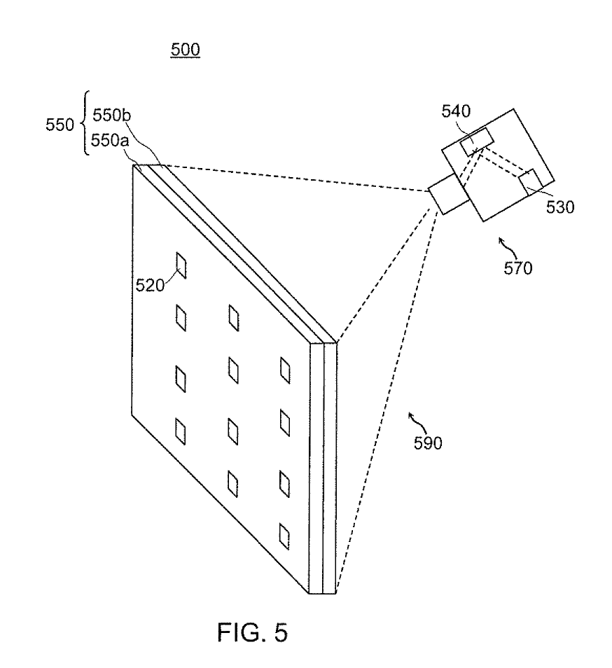

FIG. 5 illustrates a perspective view of a holographic projection display system 500. The holographic projection display system 500 comprises a light source 530 and a LCD modulator panel 540 located in an image projector 570, a holographic screen 550 and a plurality of sensors 520 embedded in the holographic screen 550. The holographic screen 550 may further comprise a main hologram 550a and a dispersion hologram 550b that causes images to appear 3D to a user on the holographic screen 550. The holographic projection display system 500 is substantially similar to the holographic projection display 400 but differs at least in the construction and arrangement of the sensors 520.

The sensors 520 in the holographic projection display system 500, as shown in the embodiment in FIG. 5 are embedded in the holographic screen 550 rather than being on a substrate 410, as shown in FIG. 4. The sensors 520 may be in any layer 550a-550b of the holographic screen 550. However, having the sensors 520 located at the main hologram layer 550a may increase the sensitivity of the sensors 520. The sensors 520 may be arranged in a periodic pattern, such as in an array form, in interlaced columns, or in any other form suitable to detect movement of a user. The sensors 520 may be configured to detect reflected light from the surrounding environment in order to detect movement of a user located near the holographic screen 550. However, as the sensors 520 are located within the path of light emission, the sensors 520 can be configured to detect the light directly from the image beam 590 that is projected from the image projector 570. Accordingly, the sensors 520 may be configured to form part of an optical feedback system to the image projector 570.

The sensors 520 may be configured to detect light from the surrounding environment by synchronizing the sensors 520 and the light source 530 of the image projector 570, as discussed in the previous embodiment. Therefore, in a first time interval, when the light sources 530 are configured to emit light, the sensors 520 may be configured to detect light from the light sources 530. However, in a second time interval, that is non-overlapping with the first time interval, the sensors 520 may be configured to detect light from the ambient environment in order to detect movement of a user.

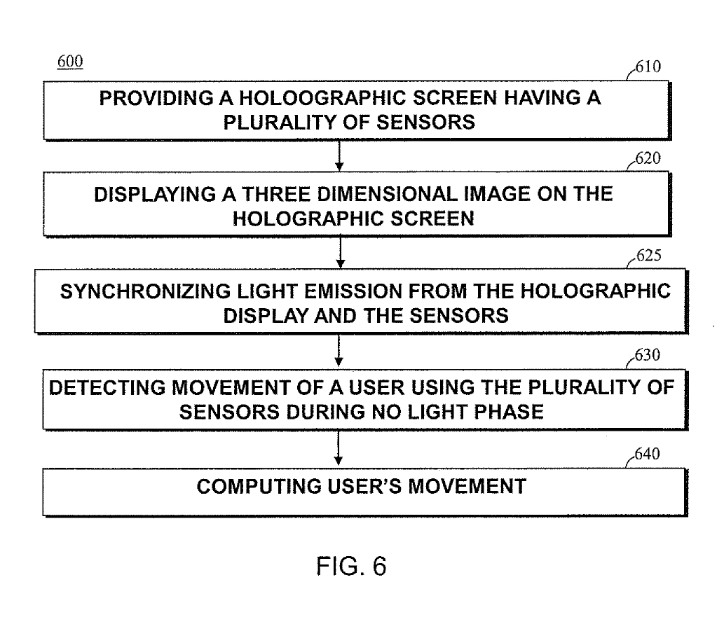

FIG. 6 shows a flowchart 600 illustrating a method for detecting a user's movement in a gaming system. In step 610, a holographic screen having a plurality of sensors is provided. The sensors may be embedded in a glass layer of the screen. Alternatively, the sensors may be attached to a PCB substrate, which is optically coupled to a light guide of the holographic screen. The holographic screen may be a portion of a flat LCD display or a portion of a projection display. In step 620, a three dimensional image is displayed on the holographic screen. Next, the method may proceed to optional step 625, or directly to step 630.

In step 625, the light redirected from the holographic display, and the sensor may be synchronized. This may be done through an image processor that is connected to the LCD panel in a flat screen display or a LCD modulator panel in a projection display. The image processor may be configured to emit a synchronized signal to both the light source driver and the sensors. In step 630, movement of a user is detected with the sensors. For example, in a first time interval in which images are displayed, the light source may be configured to emit light. In a second time interval in which the light source is not turned on, the sensors may be configured to detect ambient light. Finally in step 640, the movement of the user is computed by applying a controller to carry out a predetermined algorithm, such as correlation and spatial filtering.

Although specific embodiments of the invention have been described and illustrated herein above, the invention should not be limited to any specific forms or arrangements of parts so described and illustrated. For example, the light source die described above may be an LED die or some other light source, as known or later developed without departing from the spirit of the invention. The scope of the invention is to be defined by the claims appended hereto and their equivalents. Similarly, manufacturing embodiments and the steps thereof may be altered, combined, reordered, or other such modification as is known in the art to produce the results illustrated.

What is claimed is:

1. A holographic display system for displaying images, the holographic display system comprising:
a substrate;
a light source positioned on the substrate configured to emit light;
a display screen positioned over the substrate, the display screen having a light guide configured to receive light from the light source and a Liquid Crystal Display (LCD) panel having M×N pixels;
a holographic overlay positioned over at least a portion of the display screen, the holographic overlay causing the images to appear three-dimensional to a user; and
a plurality of sensors arranged in array for detecting motion of the user, wherein the plurality of sensors are optically coupled to the holographic overlay.

2. The holographic display system of claim 1, wherein the plurality of sensors are located on the substrate.

3. The holographic display system of claim 1, wherein the plurality of sensors are embedded in the holographic overlay.

4. The holographic display system of claim 3, wherein the plurality of sensors defines photo-diode pockets interconnected by an Indium-tin-oxide (ITO) layer.

5. The holographic display system of claim 1, wherein the plurality of sensors are highly sensitive to infrared light compared to visible light.

6. The holographic display system of claim 1, wherein the plurality of sensors are connected to a switch capacitor circuit configured to detect light during a first time interval.

7. The holographic display system of claim 6, wherein the light source is configured to emit light during a second time interval non-overlapping with the first time interval.

8. The holographic display system of claim 1 further comprising a control circuit configured to perforin correlation to detect movement of the user.

9. The holographic display system of claim 1, wherein each of the plurality of sensors further comprises an optical lens.

10. The holographic display system of claim 1, wherein the plurality of sensors are positioned in an outer perimeter of the holographic display system.

11. The holographic display system of claim 1, wherein the holographic display system forms a portion of a gaming system.

12. A holographic projection display system having an image projector and a holographic screen for displaying images, the holographic projection display system comprising:
a light source positioned in the image projector configured to emit light;
a Liquid Crystal Display (LCD) modulator panel having M×N pixels configured to receive light from the light source and to modulate light in accordance with the images;
a hologram located on the holographic screen configured to receive modulated light from the LCD modulator panel, wherein the hologram causes the images to appear three-dimensional to a user; and
a plurality of sensors arranged in array for detecting motion of the user, wherein the plurality of sensors are optically coupled to the holographic screen.

13. The holographic projection display system of claim 12, further comprising a substrate overlaying at least a portion of the holographic screen, wherein a portion of the substrate defines a hollow allowing modulated light to pass through.

14. The holographic projection display system of claim 13, wherein the plurality of sensors are located on the substrate.

15. The holographic projection display system of claim 12, wherein the plurality of sensors are embedded in the holographic screen.

16. The holographic projection display system of claim 12, wherein the plurality of sensors are highly sensitive to infrared light compared to visible light.

17. The holographic projection display system of claim 12, wherein the plurality of sensors are connected to a switch capacitor circuit configured to detect light during a first time interval.

18. The holographic projection display system of claim 17, wherein the light source is configured to emit light during a second time interval non-overlapping with the first time interval.

19. The holographic projection display system of claim 12, wherein the holographic display system forms a portion of a gaming system.

20. A holographic projection display system, comprising:
an image projector comprising:
a light source configured to emit light; and
a Liquid Crystal Display (LCD) modulator panel having M×N pixels configured to receive light from the light source and to modulate light in accordance with the images; and
a holographic screen comprising:
a hologram configured to receive modulated light from the LCD modulator panel, wherein the hologram causes the images to appear three-dimensional to a user; and
a plurality of sensors arranged in array for detecting motion of the user, wherein the sensor is optically coupled to the holographic screen.
